(19) United States
(12) Patent Application Publication
(10) Pub. No.: US 2026/0257800 A1
(43) Pub. Date: Sep. 3, 2026

(54) EMERGENCY ESCAPE PARACHUTE

(71) Applicant: HONGYU ZHOU, FOSHAN (CN)

(72) Inventor: HONGYU ZHOU, FOSHAN (CN)

(21) Appl. No.: 19/100,575

(22) PCT Filed: May 2, 2023
(86) PCT No.: PCT/CN2023/091937

§ 371 Date: Oct. 20, 2025

(30) Foreign Application Priority Data
Mar. 18, 2023 (CN) ZL2023205314777

(51) Int. Cl. B64D 25/08; B64B 1/58; B64D 17/14; B64D 17/30; B64D 17/68

(52) U.S. Cl. CPC B64D 25/08; B64B 1/58; B64D 17/14; B64D 17/30; B64D 17/68

(57) ABSTRACT

This patent discloses a emergency escape parachute and relates to the field of parachute technology. The parachute consists of a pilot parachute, a main chute, an attitude stabilizer, an inflatable system and a safety harness. The parachute covered by this patent can automatically adjust a person's body posture when descending and the parachute opening posture in the air by adding a posture stabilizer, which avoids the situation where the parachute cannot be deployed due to the parachute rope being entangled. Compared with ordinary parachutes, the biggest feature of this parachute is that users do not need to undergo long-term professional training. Users can quickly learn to use it in a short time with a simple manual, and the operation is simple, which reduces the requirements for users and expands the scope applications.

### TECHNICAL FIELD

This patent discloses a emergency escape parachute and is in the field of parachute technology.

### BACKGROUND OF THE ART

When an emergency occurs in a high-rise building or while flying a hot air balloon or flying an airplane, it is difficult for people to save themselves with the help of the existing parachute. The main reason is that a certain period of training is required before you can properly use an existing parachute. Without professional training, when using an existing parachute, there is a possibility that the parachute will not open in the air due to the person's incorrect body position, or the parachute rope will become tangled in the person's body, preventing the person from landing safely.

### SUMMARY OF THE INVENTION

The purpose of this invention is to create a emergency escape parachute that can be used without professional training and can be quickly learned and used by users for self-escape in case of an emergency.

The technical solution adopted in this invention to solve the above problems: a emergency-escape parachute, including a pilot parachute (1), a main parachute (2), a posture stabilizer (3), an inflatable system (4) and a safety harness (5) , among them, the posture stabilizer (3) is composed of a cone-shaped inflatable frame (31) and a wind fabric (32); the pilot parachute (1) is connected to the middle position of the top of the main parachute (2) through a parachute cord, the posture stabilizer (3) is connected to safety harness (5), the paracord of the main parachute (2) passes from the top through the annular air bag at the bottom of the attitude stabilizer (3) and is connected to the safety harness (5), the air bottle of the inflatable system (4) is connected to the safety harness (5), and the end of the flexible air outlet tube on the air bottle connected to the inflation hole at the bottom of the posture stabilizer (3).

Among them, the lower part of the cone-shaped inflatable frame (31) is an annular air bag, and the upper part is an inclined air column connected to the annular air bag. All air columns are evenly spaced around the circumference.

Among them, the inflatable system (4) includes a manual valve, a compressed air bottle and an air tube.

Advantages of this invention: When used in high-rise buildings or hot air balloons, first put the parachute bag on your back and fasten the seat belt, then pull the manual valve with your back outward so that the compressed air tank first inflates the position stabilizer, then it opens and takes a shape similar to badminton. After the posture stabilizer is filled with air and expands, the pilot parachute is released, at which time people can jump from buildings or hot air balloons. At the moment of jumping, under the influence of air resistance, the posture stabilizer falls like a badminton, and corrects its own posture and the downward posture of the person. At the same time, the pilot parachute is inflated and opened. Because when falling, there is no obstacle at the top of the posture stabilizer, so when the traction force of the pilot parachute is strong enough, the main parachute can be pulled out smoothly, so that the person can land safely. When used on an airplane, you can also jump out of the airplane first, and then open the manual valve in air and can also land safely.

The parachute presented in the invention itself can automatically adjust the posture of a person's body when descending and the opening posture of the parachute in the air by adding a posture stabilizer, which avoids the situation where the parachute rope gets entangled in the person's body. Compared with the traditional parachute, the biggest feature of the new parachute is that users do not need to undergo long-term professional training. They can quickly learn to use it in a short time through the simple manual, and the operation is simple, which reduces the requirements for users, expanding the scope of application.

### DESCRIPTION OF DRAWINGS

FIG. 1 is a diagram in which the parachute of the present invention is fully deployed;

FIG. 2 is a diagram in which the parachute posture stabilizer of the present invention is inflated and opened, and the pilot parachute is released.

In the picture: 1—Pilot parachute; 2—Main parachute; 3—Pose stabilizer; 31—Cone-shaped inflatable frame; 32—Wind fabric; 4—Inflatable system; 5—safety harness.

### DETAILED DESCRIPTION OF THE EMBODIMENTS

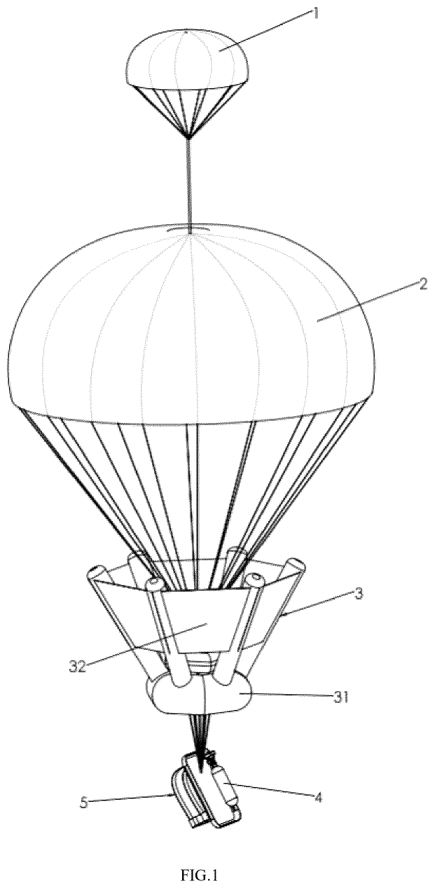

As shown in FIG. 1, a emergency escape parachute has a structure including a pilot parachute 1, a main parachute 2, a posture stabilizer 3, an inflatable system 4 and safety harness 5. The posture stabilizer 3 consists of a cone-shaped inflatable frame 31 and wind fabric 32. Among them, the lower part of the cone-shaped inflatable frame 31 is an annular air bag, and the upper part is an inclined air column connected to the annular air bag. All air columns are evenly spaced around the circumference. Among them, the inflatable system 4 includes a manual valve, a compressed air tank and an air tube.

The cone-shaped inflatable frame of the present invention can be made of nylon fabric coated with TPU material or polyurethane material. The windproof fabric is placed between each two adjacent air columns of the cone-shaped inflatable frame. The windproof fabric can be made of ordinary nylon fabric, the air bottle of the inflatable system uses ordinary compressed air, one end of the air tube is connected to a cylinder, and the other end is connected to a cone-shaped inflatable frame. Typically the guide chute, main chute, posture stabilizer and inflatable system are packed together in a parachute bag. The main parachute is wrapped and placed over a ring-shaped cushion of air inside the cone-shaped inflatable frame of the parachute. If an emergency occurs in a high-rise building or in a hot air balloon, the person must first put on the parachute bag and fasten the harness. If the person is in a small space, he may turn his back outward to open space.

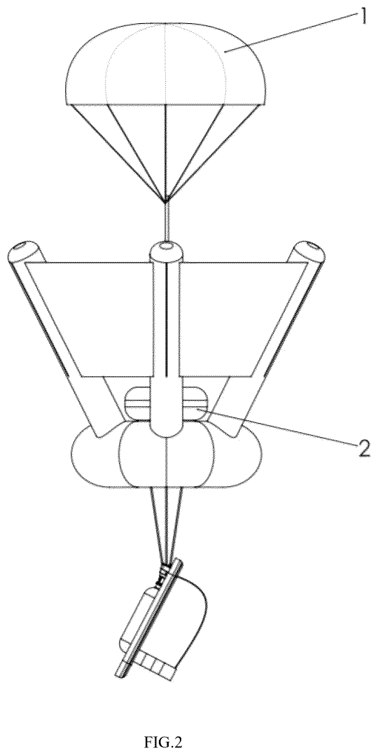

At this time, the manual valve can be pulled, the cone-shaped inflatable frame is inflated and deployed first, and the guide parachute is released, as shown in FIG. 2. At this time, the main parachute is still in the small parachute bag. If at this time a person jumps from a height and descends into air, the posture stabilizer will always fall like a badminton. At this time, the guide parachute will inflate and open. Since there are no obstacles in the upper space of the main parachute, when the pulling force of the guide chute is sufficient, the main parachute is smoothly pulled out of the parachute bag and deployed. After the main parachute is deployed, personnel can land safely.

In the event of an emergency on an airplane, personnel can also carry a parachute bag and fasten a seat belt, then jump out of the airplane, immediately open the manual valve after jumping. At this time, the posture stabilizer quickly inflates, adjusting the person's own posture and that of the person. No matter what the personnel's initial posture is in the air, under the action of the posture stabilizer, they can automatically enter a stable downward posture. Once the attitude stabilizer deploys, the pilot parachute is released and the pilot parachute is inflated and deployed. With sufficient tension, the main parachute is smoothly pulled out of the parachute compartment and deployed. Once the main parachute deploys, the person can land safely.

1. A emergency escape parachute, characterized in that it includes a pilot parachute (1), a main parachute (2), a posture stabilizer (3), an inflatable system (4) and a safety harness (5), among them a posture stabilizer (3) consists of a cone-shaped inflatable frame (31) and wind fabric (32).

2. A emergency escape parachute according to claim 1, characterized in that the lower part of the cone-shaped inflatable frame (31) is an annular air bag, and the upper part is an inclined inflatable columns connected to the annular air bag, and all inflatable columns are evenly spaced around the circumference.
